(19) United States
(12) Patent Application Publication
(10) Pub. No.: US 2026/0069982 A1
(43) Pub. Date: Mar. 12, 2026

(54) INFORMATION PROCESSING DEVICE AND IMAGE GENERATION METHOD

(71) Applicant: Sony Interactive Entertainment Inc., Tokyo (JP)

(72) Inventors: Yurika Kondo, Tokyo (JP); Kuniaki Oe, Tokyo (JP); Haruka Iwaki, Kanagawa (JP)

(73) Assignee: Sony Interactive Entertainment Inc., Tokyo (JP)

(21) Appl. No.: 19/393,038

(22) Filed: Nov. 18, 2025

Related U.S. Application Data
(63) Continuation of application No. PCT/JP2023/018891, filed on May 22, 2023.

(51) Int. Cl. A63F 13/60; A63F 13/52

(52) U.S. Cl. CPC A63F 13/60; A63F 13/52

(57) ABSTRACT

An image generation section 240 generates a real space image to be displayed on a head-mounted display worn on the head of a user. A reference direction acquisition section 230 acquires a reference direction associated with the line of sight of the user. The image generation section 240 arranges an information element in the real space image at a position derived on the basis of the reference direction. The image generation section 240 changes the position of the information element in the real space image when, after the information element is arranged, a state in which the reference direction deviates by a predetermined angle or more from the reference direction used at the time of arranging the information element has continued for a predetermined period of time.

### TECHNICAL FIELD

The present disclosure relates to a technology for generating an image to be displayed on a head-mounted display (hereinafter referred to also as an “HMD”).

### BACKGROUND ART

In recent years, it has been popular that a user wears an HMD on the head and plays a game by operating a game controller while watching a game video of a three-dimensional virtual reality (VR) space displayed on the HMD. By performing tracking processing of the HMD and causing the game video to proceed in coordination with motion of the head of the user, it is possible not only to provide a higher sense of immersion into a video world but also to enhance entertainability of the game.

PTL 1 discloses an information processing device that presents a planar video (two-dimensional video) to a user wearing an HMD. This information processing device has a first display mode in which the planar video is always displayed in a front direction of the user and a second display mode in which the planar video is displayed in a manner changing according to changes in position and/or orientation of the HMD, and has a function of performing switching between the first display mode and the second display mode on the basis of a given condition.

### CITATION LIST

### Patent Literature

[PTL 1]
PCT Patent Publication No. WO2017/051564

### SUMMARY

### Technical Problem

The present disclosers have tried various ways of image displaying on HMDs and have figured out that some ways of image displaying may make it hard for the user to check the current situation. The present disclosers have confirmed that, in a case in which a dialogue box that is a two-dimensional video is displayed on an HMD, for example, the user may feel discomfort depending on the way of displaying. On the basis of knowledge obtained through various trials, the present disclosers have conceived of display control suitable for HMDs.

Accordingly, it is an object of the present disclosure to provide a technology for effectively generating an image to be displayed on an HMD.

### Solution to Problem

According to an embodiment of the present disclosure, there is provided an information processing device including one or more processors having hardware, in which the one or more processors generate a real space image to be displayed on a head-mounted display worn on the head of a user, acquire a reference direction associated with the line of sight of the user, arrange an information element in the real space image at a position derived on the basis of the reference direction, and change the position of the information element in the real space image when, after the information element is arranged, a state in which the reference direction deviates by a predetermined angle or more from the reference direction used at the time of arranging the information element has continued for a predetermined period of time.

According to another embodiment of the present disclosure, there is provided an image generation method including a step of generating a real space image to be displayed on a head-mounted display worn on the head of a user, a step of acquiring a reference direction associated with the line of sight of the user, a step of arranging an information element in the real space image at a position derived on the basis of the reference direction, and a step of changing the position of the information element in the real space image when, after the information element is arranged, a state in which the reference direction deviates by a predetermined angle or more from the reference direction used at the time of arranging the information element has continued for a predetermined period of time.

It is to be noted that any combinations of the components described above as well as modes obtained by transforming the expressions of the present disclosure among methods, devices, systems, computer programs, recording media on which computer programs are recorded in a readable manner, data structures, and the like are also effective as aspects of the present disclosure.

### BRIEF DESCRIPTION OF DRAWINGS

FIG. 1 is a diagram illustrating a configuration example of an information processing system according to an embodiment.

FIG. 2 is a diagram illustrating an exemplary appearance shape of an HMD.

FIG. 3 is a diagram illustrating functional blocks of the HMD.

FIG. 4(a) is a diagram illustrating a shape of a left-hand input device, and FIG. 4(b) is a diagram illustrating a shape of a right-hand input device.

FIG. 5 is a diagram illustrating the shape of the right-hand input device.

FIG. 6 is a diagram illustrating a hardware configuration of an information processing device.

FIG. 7 is a diagram illustrating functional blocks of the information processing device.

FIG. 8 is a diagram illustrating an example of a real space in which a user exists.

FIG. 9 is a diagram illustrating an example of a surrounding image.

FIG. 10 is a diagram illustrating an example of an information element.

FIG. 11 is a diagram for explaining a method for deriving an arrangement position of the information element.

FIG. 12 is a diagram illustrating an example of the arrangement position of the information element in a virtual space.

FIG. 13 is a diagram illustrating an example of the information element.

FIG. 14 is a diagram illustrating an example of the information element.

FIG. 15 is a diagram illustrating a flowchart for determining the arrangement position of the information element.

FIG. 16 is a diagram illustrating an example of the arrangement position of the information element in the virtual space.

FIG. 17 is a diagram illustrating an example of the arrangement position of the information element in the virtual space.

FIG. 18 is a diagram illustrating an example of the information element.

### DESCRIPTION OF EMBODIMENT

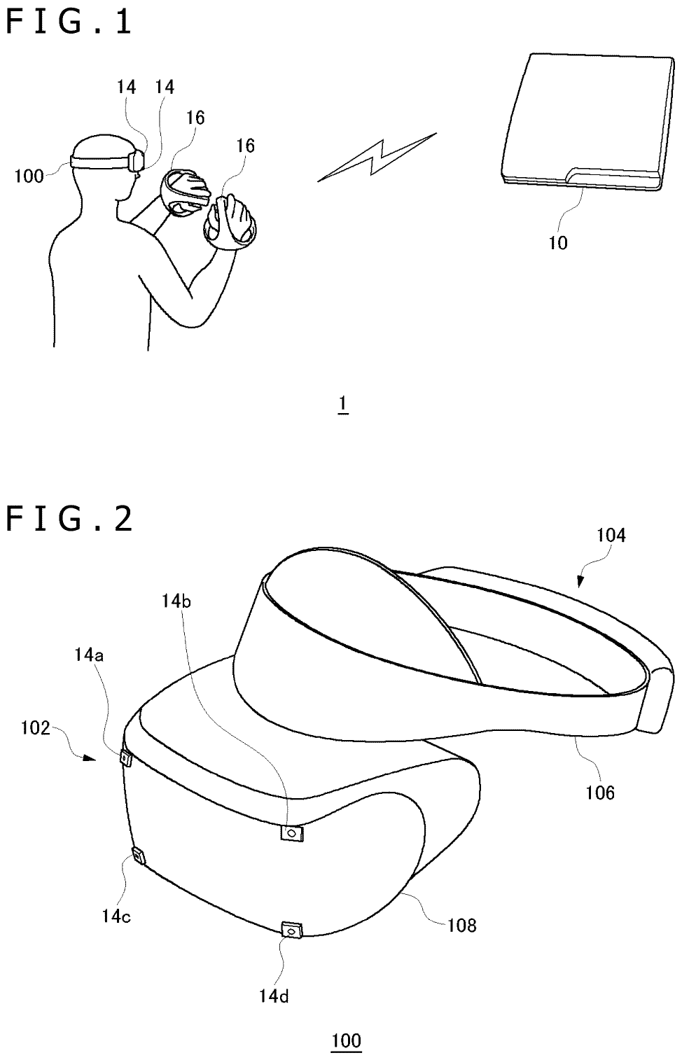

FIG. 1 illustrates a configuration example of an information processing system 1 according to an embodiment. The information processing system 1 includes an information processing device 10, a head-mounted display (HMD) 100 that is worn on the head of a user, and input devices 16 that are gripped by the hands of the user and operated with the fingers. The information processing device 10 executes game software and provides the HMD 100 with image data and audio data of the game. The information processing device 10 and the HMD 100 may be connected to each other by a known wireless communication protocol or may be connected to each other by a cable.

The HMD 100 is a display device that displays images on display panels positioned in front of the eyes of the user when the user wears the HMD 100 on the head, and is also called a VR headset. The HMD 100 displays a left-eye image on a left-eye display panel and a right-eye image on a right-eye display panel separately. These images constitute parallax images viewed from left and right viewpoints and realize stereoscopic vision. Since the user looks at the display panels through optical lenses, the information processing device 10 provides the HMD 100 with parallax image data for which optical distortion due to the lenses has been corrected.

The information processing device 10 and the input devices 16 may be connected to each other by a known wireless communication protocol or may be connected to each other by a cable. Each of the input devices 16 has a plurality of operation members such as operation buttons, and the user operates the operation members with the fingers of the relevant hand while gripping the input device 16. When the information processing device 10 executes a game, the input devices 16 are used as game controllers. Each of the input devices 16 has an inertial measurement unit (IMU) including a triaxial acceleration sensor and a triaxial angular velocity sensor and transmits sensor data to the information processing device 10 in a predetermined cycle (800 Hz, for example).

Each of the input devices 16 is provided with a plurality of markers (light emitting sections) that can be imaged by imaging devices 14, enabling tracking of the position and posture of the input device 16 in a real space. The information processing device 10 has a function of analyzing the image captured of the input device 16 and estimating the position and posture of the input device 16 in the real space.

The HMD 100 is mounted with the plurality of imaging devices 14. The plurality of imaging devices 14 are attached to a front surface of the HMD 100 at different positions with different postures such that an overall imaging range obtained by adding up respective imaging ranges of the imaging devices 14 includes the entire field of vision of the user. Each of the imaging devices 14 includes an image sensor capable of capturing images of the plurality of markers of the input devices 16. In a case in which the markers emit visible light, for example, each of the imaging devices 14 includes a visible light sensor, such as a charge coupled device (CCD) sensor or a complementary metal oxide semiconductor (CMOS) sensor, which is used in common digital video cameras. In a case in which the markers emit invisible light, each of the imaging devices 14 includes an invisible light sensor. The plurality of imaging devices 14 capture images of a space in front of the user in a predetermined cycle (120 frames per second, for example) in synchronization with one another and transmit image data obtained by the imaging of the real space to the information processing device 10.

FIG. 2 illustrates an exemplary appearance shape of the HMD 100. The HMD 100 includes an output mechanism section 102 and a mounting mechanism section 104. The mounting mechanism section 104 includes a wearing band 106 that is, when the user puts the HMD 100 on the head, wound around the head and fixes the HMD 100 to the head. The wearing band 106 has such a material or structure as to allow adjustment of its length according to the circumference of the head of the user.

The output mechanism section 102 includes a housing 108 having such a shape that the left and right eyes of the user are covered by the housing 108 when the user wears the HMD 100, and in the housing 108, display panels facing the eyes when the user wears the HMD 100 are provided. The display panels may be liquid crystal panels, organic EL panels, or the like. In the housing 108, in addition, there are a pair of left and right optical lenses that are located between the display panels and the eyes of the user and enlarge the viewing angle of the user. The HMD 100 may further include speakers and earphones at positions corresponding to the ears of the user, or may be connected to external headphones.

On a front outer surface of the housing 108, a plurality of imaging devices 14a, 14b, 14c, and 14d are provided. With a front direction of the face of the user as a reference, the imaging device 14a is attached to an upper right corner of the front outer surface to have its camera optical axis oriented obliquely upward to the right, the imaging device 14b is attached to an upper left corner of the front outer surface to have its camera optical axis oriented obliquely upward to the left, the imaging device 14c is attached to a lower right corner of the front outer surface to have its camera optical axis oriented obliquely downward to the right, and the imaging device 14d is attached to a lower left corner of the front outer surface to have its camera optical axis oriented obliquely downward to the left. With the plurality of imaging devices 14 arranged in this manner, the overall imaging range obtained by adding up the respective imaging ranges of the imaging devices 14 includes the entire field of vision of the user.

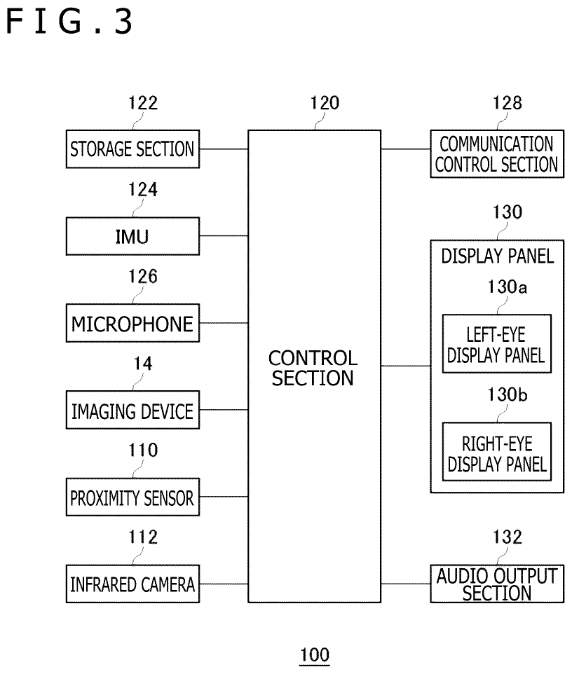

FIG. 3 illustrates functional blocks of the HMD 100. A control section 120 is a main processor that processes and outputs various kinds of data such as image data, audio data, and sensor data as well as commands. A storage section 122 temporarily stores the data and commands processed by the control section 120, and the like. An IMU 124 acquires sensor data relating to motion of the HMD 100. The IMU 124 may include at least a triaxial acceleration sensor and a triaxial angular velocity sensor. The IMU 124 detects values (sensor data) of each axis component in a predetermined cycle (800 Hz, for example). A proximity sensor 110 detects a state in which the user wears the HMD 100. An infrared camera 112 is provided in the housing 108 and images the eyes of the user to track the line of sight of the user.

A communication control section 128 transmits the data output from the control section 120, to the external information processing device 10 via a network adapter or an antenna by wired or wireless communication. Further, the communication control section 128 receives data from the information processing device 10 and outputs the data to the control section 120.

Upon receiving image data and audio data from the information processing device 10, the control section 120 provides a display panel 130 with the image data to cause the display panel 130 to display images, and provides an audio output section 132 with the audio data to cause the audio output section 132 to output sound. The display panel 130 includes a left-eye display panel 130a and a right-eye display panel 130b, and a pair of parallax images are displayed on the respective display panels. Moreover, the control section 120 causes the sensor data detected by the IMU 124, audio data acquired by a microphone 126, image data captured by the imaging devices 14, sensor data acquired by the proximity sensor 110, and image data captured by the infrared camera 112 to be transmitted from the communication control section 128 to the information processing device 10.

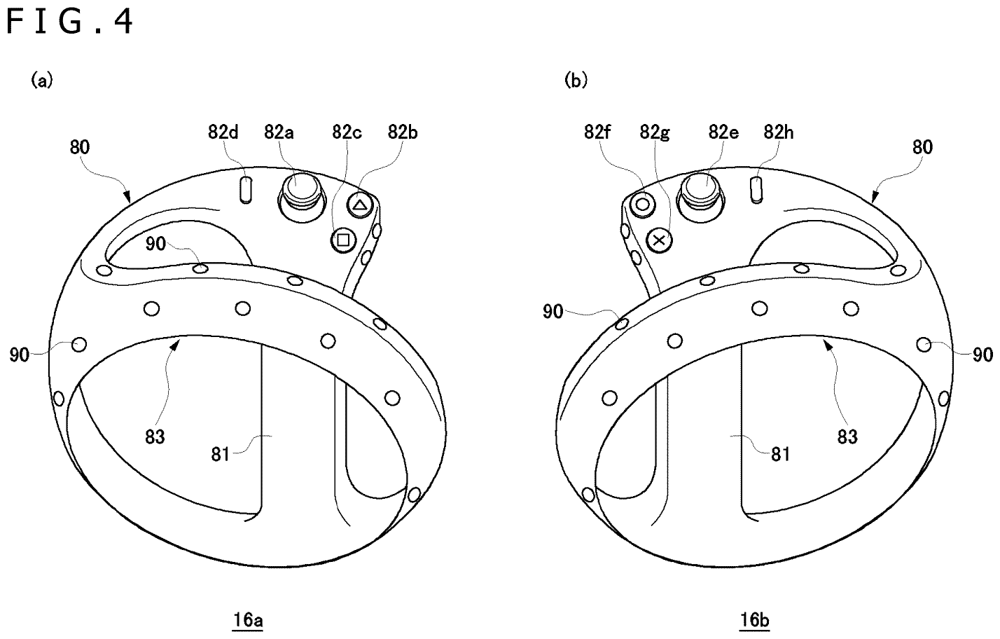

FIG. 4(a) illustrates a shape of a left-hand input device 16a. The left-hand input device 16a includes a case body 80, a plurality of operation members 82a, 82b, 82c, and 82d (hereinafter called the “operation members 82” unless there is a need to make a distinction among them) operated by the user, and a plurality of markers 90 that emit light to the outside of the case body 80. It is to be noted that, in FIG. 4(a), only some of the markers are assigned reference signs. Each of the markers 90 may have an emitting portion that is circular in cross section. The operation members 82 may include an analog stick to be tilted for operation, a depression-type button, and the like. The case body 80 includes a grip 81 and a curved portion 83 connecting a case body head portion and a case body bottom portion to each other, and the user inserts the left hand through the curved portion 83 and grips the grip 81. In the state of gripping the grip 81, the user operates the operation members 82a, 82b, 82c, and 82d with the thumb of the left hand.

FIG. 4(b) illustrates a shape of a right-hand input device 16b. The right-hand input device 16b includes a case body 80, a plurality of operation members 82e, 82f, 82g, and 82h (hereinafter called the “operation members 82” unless there is a need to make a distinction among them) operated by the user, and a plurality of markers 90 that emit light to the outside of the case body 80. In FIG. 4(b) as well, only some of the markers are assigned reference signs. The operation members 82 may include an analog stick to be tilted for operation, a depression-type button, and the like. The case body 80 includes a grip 81 and a curved portion 83 connecting a case body head portion and a case body bottom portion to each other, and the user inserts the right hand through the curved portion 83 and grips the grip 81. In the state of gripping the grip 81, the user operates the operation members 82e, 82f, 82g, and 82h with the thumb of the right hand.

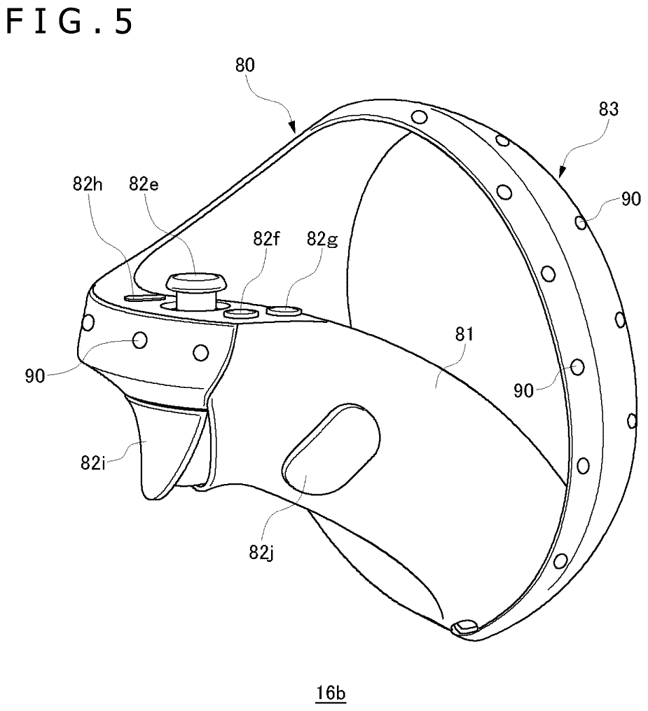

FIG. 5 illustrates the shape of the right-hand input device 16b. The input device 16b includes operation members 82i and 82j in addition to the operation members 82e, 82f, 82g, and 82h illustrated in FIG. 4(b). In the state of gripping the grip 81, the user operates the operation member 82i with the index finger of the right hand and operates the operation member 82j with the middle finger of the right hand. Hereinafter, the input device 16a and the input device 16b are called the “input devices 16” unless there is a need to make a distinction between them.

The markers 90 are light emitting sections that emit light to the outside of the case body 80, and each include, on a surface of the case body 80, a resin portion for externally diffusing and emitting light supplied from a light source such as a light emitting diode (LED) element. The markers 90 are imaged by the imaging devices 14, and the images thereof are used for tracking processing of the input devices 16.

The information processing device 10 uses the images captured by the imaging devices 14, for tracking processing of the input devices 16 and simultaneous localization and mapping (SLAM) processing of the HMD 100. In the embodiment, among images captured by the imaging devices 14 at 120 frames per second, gray-scale images captured at 60 frames per second may be used for tracking processing of the input devices 16, and other full-color images captured at 60 frames per second may be used for processing of simultaneously executing self-position estimation of the HMD 100 and environmental map creation.

The information processing device 10 is capable of causing the HMD 100 to operate in a “see-through viewing” mode. In the see-through viewing mode, the information processing device 10 generates an image of the real space in the direction in which the user faces, on the basis of the images captured by the imaging devices 14, and provides the HMD 100 with the generated image. The HMD 100 displays the image of the real space on the display panel 130. As a result, the user can see the surroundings in the state of wearing the HMD 100. When the user wants to play a VR game, since it is difficult for the user to put on the HMD 100 in the state of holding the input devices 16 by both hands, the user first puts on the HMD 100 and then grips the two input devices 16 by both hands. Although the field of view of the user is blocked when the user wears the HMD 100 on the head, the HMD 100 displays the real space image on the display panel 130 in the “see-through viewing” mode, so that the user can find the input devices 16 and hold them by both hands.

In the see-through viewing mode, the information processing device 10 can notify the user of information by arranging an information element such as a dialogue box in the real space image displayed on the display panel 130. Since the input devices 16 in the embodiment are game controllers of an unconventional shape, in a case in which the user uses the input devices 16 for the first time or for the first time in a while, the HMD 100 may display an information element in the real space image, thereby providing the user with guidance regarding how to use the input devices 16. Besides, it is preferable in some cases that the HMD 100 present the user with some kind of information during the see-through viewing mode. Through various kinds of experimentation, the present disclosers have deduced a method for effectively presenting the user with an information element such as a dialogue box.

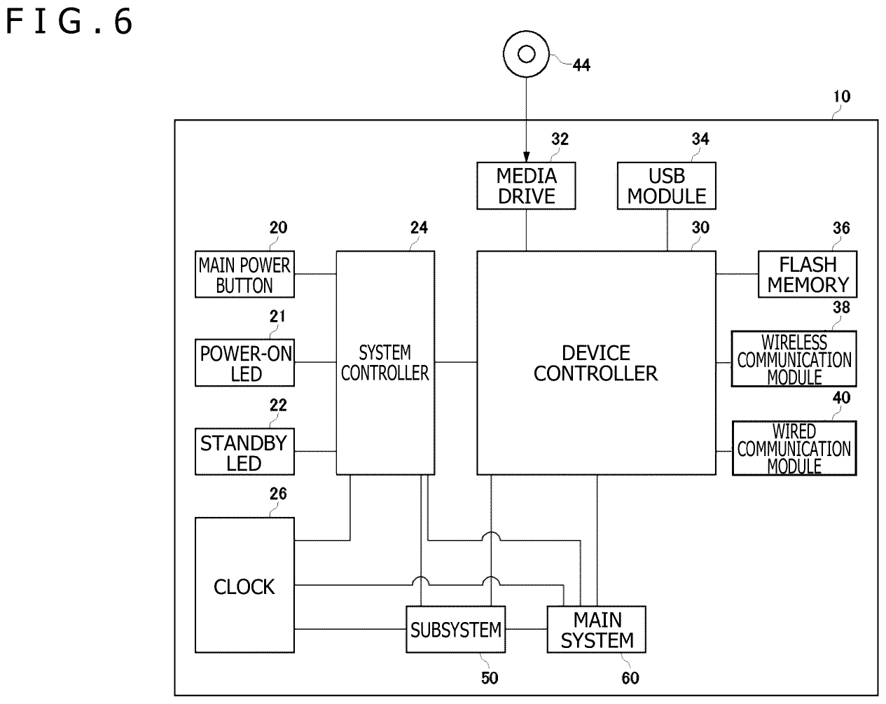

FIG. 6 illustrates a hardware configuration of the information processing device 10. The information processing device 10 includes a main power button 20, a power-on LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main central processing unit (CPU), a memory and a memory controller as a main storage, a graphics processing unit (GPU), and the like. The GPU is used mainly for arithmetic processing of a game program. These functions may be formed as a system-on-a-chip and may be formed on one chip. The main CPU has a function of executing a game program recorded on an auxiliary storage.

The subsystem 50 includes a sub-CPU, a memory and a memory controller as a main storage, and the like, does not include a GPU, and does not have a function of executing a game program. The number of circuit gates of the sub-CPU is smaller than the number of circuit gates of the main CPU, and power consumption for operation of the sub-CPU is smaller than power consumption for operation of the main CPU. The sub-CPU operates also during a period when the main CPU is in a standby state, and the processing function of the sub-CPU is restricted for the purpose of reducing the power consumption.

The main power button 20 is an input section on which the user performs input operation, is disposed on a front surface of a housing of the information processing device 10, and is operated to turn on or off power supply to the main system 60 of the information processing device 10. The power-on LED 21 is lit when the main power button 20 is turned on, whereas the standby LED 22 is lit when the main power button 20 is turned off.

The system controller 24 detects depression of the main power button 20 by the user. When the main power button 20 is depressed while the main power supply is off, the system controller 24 acquires the depressing operation as an “on instruction.” When the main power button 20 is depressed while the main power supply is on, on the other hand, the system controller 24 acquires the depressing operation as an “off instruction.”

The clock 26 is a real-time clock, generates information regarding the current date and time, and provides the system controller 24, the subsystem 50, and the main system 60 with the information. The device controller 30 is formed as a large-scale integrated circuit (LSI) that transfers information between devices, like a south bridge. As illustrated, the device controller 30 is connected to devices such as the system controller 24, the media drive 32, the USB module 34, the flash memory 36, the wireless communication module 38, the wired communication module 40, the subsystem 50, and the main system 60. The device controller 30 absorbs differences in electrical properties and differences in data transfer speed among the respective devices and controls timing of data transfer.

The media drive 32 is a drive device that is driven when mounted with a ROM medium 44 having software of a game or the like and license information recorded thereon and that reads programs, data, and the like from the ROM medium 44. The ROM medium 44 is a read-only recording medium such as an optical disc, a magneto-optical disc, or a Blu-ray disc.

The USB module 34 is a module for connecting to external equipment by a USB cable. The USB module 34 may establish connection to an auxiliary storage such as an SSD or an HDD by a USB cable. The flash memory 36 is an auxiliary storage constituting an internal storage. The wireless communication module 38 establishes wireless communication with the input devices 16 and the HMD 100 by a communication protocol such as a Bluetooth (registered trademark) protocol or an IEEE802.11 protocol. The wired communication module 40 establishes wired communication with external equipment (not illustrated).

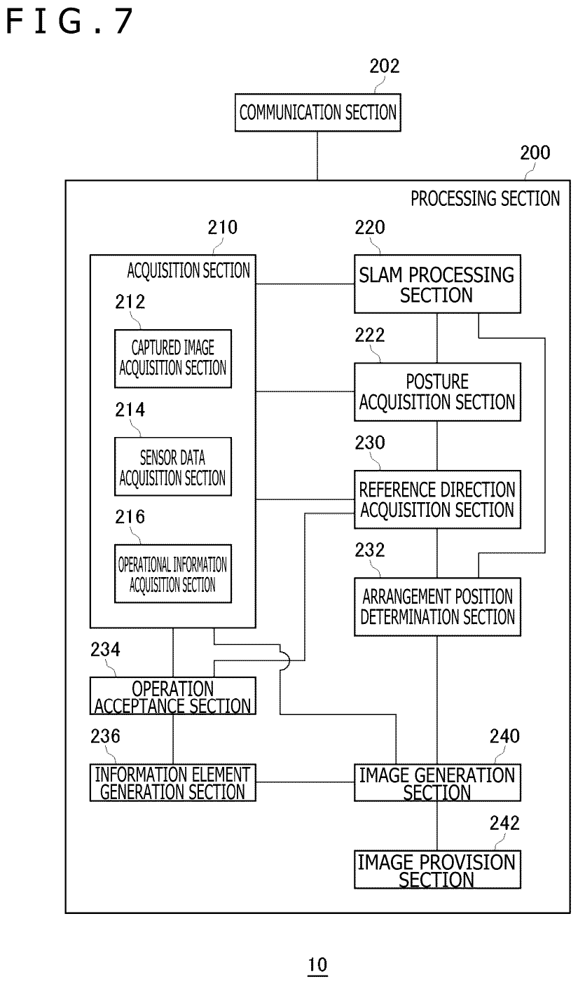

FIG. 7 illustrates functional blocks of the information processing device 10 that implements the see-through viewing function. The information processing device 10 includes a processing section 200 and a communication section 202, and the processing section 200 includes an acquisition section 210, an SLAM processing section 220, a posture acquisition section 222, a reference direction acquisition section 230, an arrangement position determination section 232, an operation acceptance section 234, an information element generation section 236, an image generation section 240, and an image provision section 242. The acquisition section 210 includes a captured image acquisition section 212, a sensor data acquisition section 214, and an operational information acquisition section 216.

The information processing device 10 includes a computer and implements the various functions illustrated in FIG. 7 by the computer executing programs. The computer includes, in terms of hardware, a memory onto which a program is loaded, one or more processors that execute the loaded program, an auxiliary storage, other LSIs, and the like. The processors are formed by a plurality of electronic circuits including a semiconductor integrated circuit and an LSI, and the plurality of electronic circuits may be mounted on one chip or may be mounted on a plurality of chips. The functional blocks illustrated in FIG. 7 are implemented by cooperation of hardware and software, and hence, it is understood by those skilled in the art that these functional blocks can be implemented in various manners by hardware only, by software only, or by a combination of them. It is to be noted that FIG. 7 illustrates the functions for implementing the see-through viewing mode by the HMD 100 and that functions for implementing tracking processing of the input devices 16 and the like are omitted from the illustration.

The communication section 202 receives operational information regarding the operation members 82 and sensor data which are transmitted from the input devices 16 and provides the acquisition section 210 with the operational information and the sensor data. The communication section 202 further receives captured image data and sensor data which are transmitted from the HMD 100 and provides the acquisition section 210 with the captured image data and the sensor data.

The captured image acquisition section 212 acquires, from the HMD 100, images captured by the imaging devices 14 and images captured by the infrared camera 112. The sensor data acquisition section 214 acquires, from the HMD 100, sensor data detected by the various sensors and acquires, from the input devices 16, sensor data detected by the IMU. The operational information acquisition section 216 acquires operational information regarding operation performed on the operation members 82 of the input devices 16 by the user. Various kinds of processing performed by the information processing device 10 are described below.

(SLAM processing) The captured image acquisition section 212 acquires full-color images for SLAM processing captured by the imaging devices 14 of the HMD 100 and provides the SLAM processing section 220 with the full-color images. The sensor data acquisition section 214 acquires sensor data detected by the IMU 124 of the HMD 100 and provides the SLAM processing section 220 with the sensor data. The SLAM processing section 220 simultaneously executes self-position estimation of the HMD 100 and environmental map creation on the basis of the image data provided from the captured image acquisition section 212 and the sensor data provided from the sensor data acquisition section 214.

The SLAM processing section 220 creates a three-dimensional map of a global coordinate system by combining pieces of three-dimensional data measured from the captured images, and estimates the position and posture of the HMD 100 on the three-dimensional map. This three-dimensional map is created with the real space appearing in the captured images regarded as one virtual space, and defines a relative positional relation between the HMD 100 and an object (a wall, a floor, or a television, for example) existing in the real space. The SLAM processing section 220 generates the virtual space corresponding to the real space from the images captured by the imaging devices 14, so that the information processing device 10 can recognize the positional relation between the user wearing the HMD 100 on the head and surrounding objects and assist the user in playing a game safely.

(Image generation processing) The image generation section 240 generates a real space image to be displayed on the HMD 100. In the see-through viewing mode, the image generation section 240 generates, as a real space image, a surrounding image with the HMD 100 as a reference point by use of the images captured by the imaging devices 14. This surrounding image is an image of the real space with a sight direction coinciding with the direction in which the HMD 100 faces, and preferably is substantially the same (that is, has the same field of vision) as the real space that the user can see when the user removes the HMD 100 from the head. Since the positional relation of the four imaging devices 14 and the orientation of the camera optical axes are known in the embodiment, the image generation section 240 can generate a left-eye surrounding image and a right-eye surrounding image by combining the images captured by the plurality of imaging devices 14.

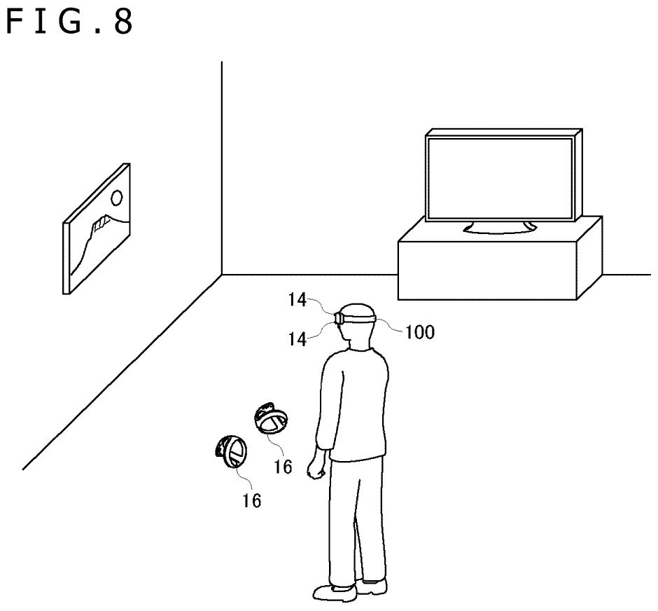

FIG. 8 illustrates an example of the real space in which the user exists. It is to be noted that the space of FIG. 8 is illustrated here as the real space but corresponds to the virtual space generated by the SLAM processing section 220. This space is the user's room, where a painting of Mt. Fuji is hung on a wall in the front direction of the user, and a television is installed in a right direction of the user. Further, the two input devices 16 are placed on the floor. Since it is not possible for the user to put on the HMD 100 on the head in the state of holding the input devices 16, the user first puts on the HMD 100 and then grips the input devices 16 by both hands.

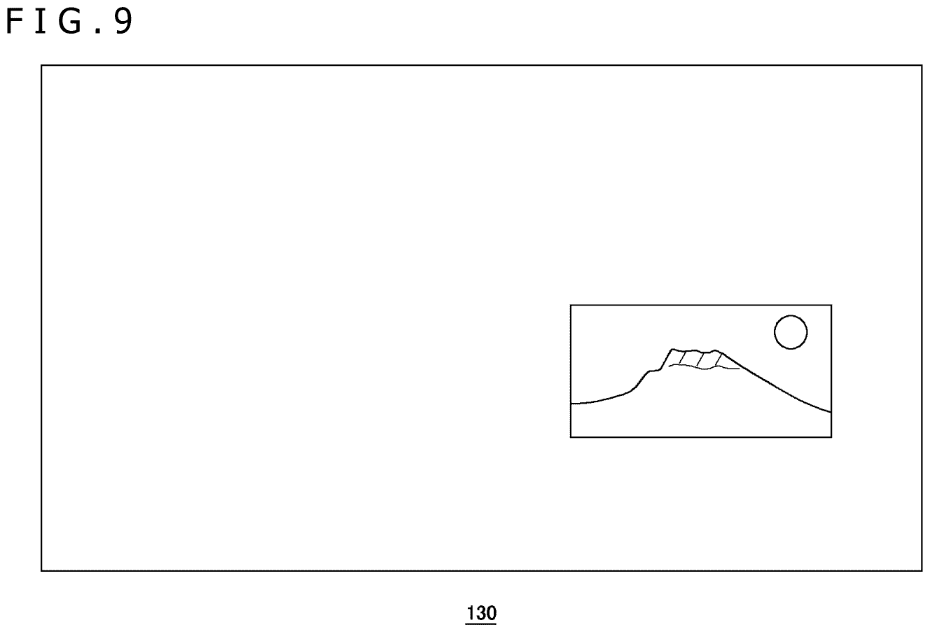

FIG. 9 illustrates an example of the surrounding image displayed on the display panel 130 in the see-through viewing mode. The image generation section 240 generates the left-eye surrounding image and the right-eye surrounding image by combining the images captured by the plurality of imaging devices 14. Description below is given with no particular distinction between the right-eye image and the left-eye image. The image generation section 240 may generate the surrounding image by using gray-scale images captured at 60 frames per second or may generate the surrounding image by using full-color images captured at 60 frames per second. The image generation section 240 generates the surrounding image with the sight direction coinciding with the direction in which the HMD 100 faces, and the image provision section 242 provides the HMD 100 with the generated surrounding image through the communication section 202. Therefore, in the state of wearing the HMD 100, the user can see the surrounding image with a field of vision equivalent to that obtained when the user does not wear the HMD 100. For example, if the user turns right, a surrounding image including the television is displayed on the display panel 130.

It is to be noted that, when the see-through viewing mode is ended and the user starts a game play, the image generation section 240 may execute the game program on the basis of the operational information regarding the operation performed on the input devices 16 by the user and generate game images.

(Reference direction acquisition processing) The reference direction acquisition section 230 acquires a reference direction associated with the line of sight of the user. The reference direction acquisition section 230 may set the reference direction according to the posture of the HMD 100. The posture acquisition section 222 acquires the posture of the HMD 100 on the basis of the sensor data of the IMU 124. At this time, the posture acquisition section 222 may set the posture of the HMD 100 by use of the position of the HMD 100 estimated by the SLAM processing section 220. It is to be noted that, if the SLAM processing section 220 has successfully estimated the posture of the HMD 100, the posture acquisition section 222 may acquire the posture of the HMD 100 from the SLAM processing section 220. The reference direction acquisition section 230 may specify the direction in which the HMD 100 faces (that is, the front direction of the face of the user) on the basis of the posture of the HMD 100 and may acquire that direction as the reference direction. It is to be noted that the reference direction acquisition section 230 may acquire, as the reference direction, a direction obtained by changing the direction in which the HMD 100 faces vertically by a predetermined angle (approximately five degrees, for example).

It is to be noted that the reference direction acquisition section 230 may acquire, as the reference direction, the sight direction of the user. In this case, the reference direction acquisition section 230 specifies the sight direction of the user on the basis of the images that are captured by the infrared camera 112 and acquired by the captured image acquisition section 212. For example, the reference direction acquisition section 230 may acquire, as the reference direction, a direction between the sight direction of the left eye and the sight direction of the right eye.

(Operation in see-through viewing mode) Operation of the information processing device 10 in the see-through viewing mode is described below. When the user uses the input devices 16 for the first time, for example, the information processing device 10 may provide the user with an information element for guidance regarding how to use the input devices 16. By providing the user with the information element in the see-through viewing mode, the information processing device 10 allows the user to test operation of the input devices 16 in accordance with the guidance while checking the surrounding situation. Now described is an example in which the information processing device 10 overlays an information element for guidance regarding how to use the input devices 16 on the real space image and provides the user with the overlaid image.

The information element generation section 236 generates an information element for providing the user with guidance information. The information element generation section 236 may generate the information element in the form of a dialogue box. The dialogue box may be displayed at the time of initial settings when the user uses the input devices 16 for the first time, or may be displayed when the user operates a predetermined button (not illustrated) provided on the HMD 100.

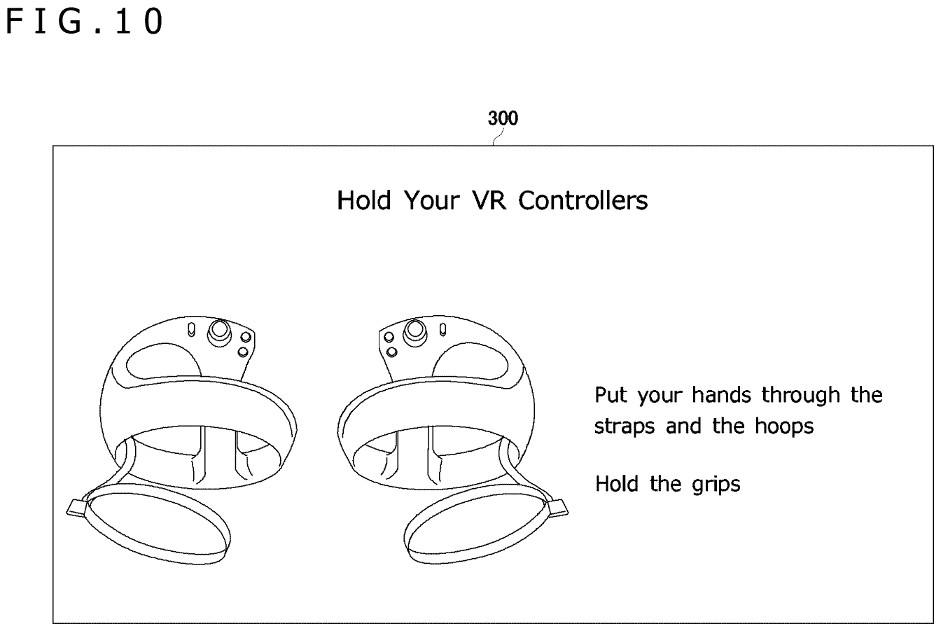

FIG. 10 illustrates an example of an information element 300. The information element 300 for presenting guidance may be generated as a still image or may be generated as a moving image. While the information element 300 in the embodiment is a dialogue box having a two-dimensionally rectangular shape, it may have any other shape. Further, while the information element 300 in the embodiment is an opaque dialogue box, it may be a translucent dialogue box.

The arrangement position determination section 232 determines the position to arrange the information element 300 in a three-dimensional virtual space constructed by the SLAM processing section 220. This three-dimensional virtual space corresponds to the real space and defines a relative positional relation with respect to the HMD 100. In the embodiment, the arrangement position determination section 232 derives an initial position of the information element 300 on the basis of the reference direction acquired by the reference direction acquisition section 230.

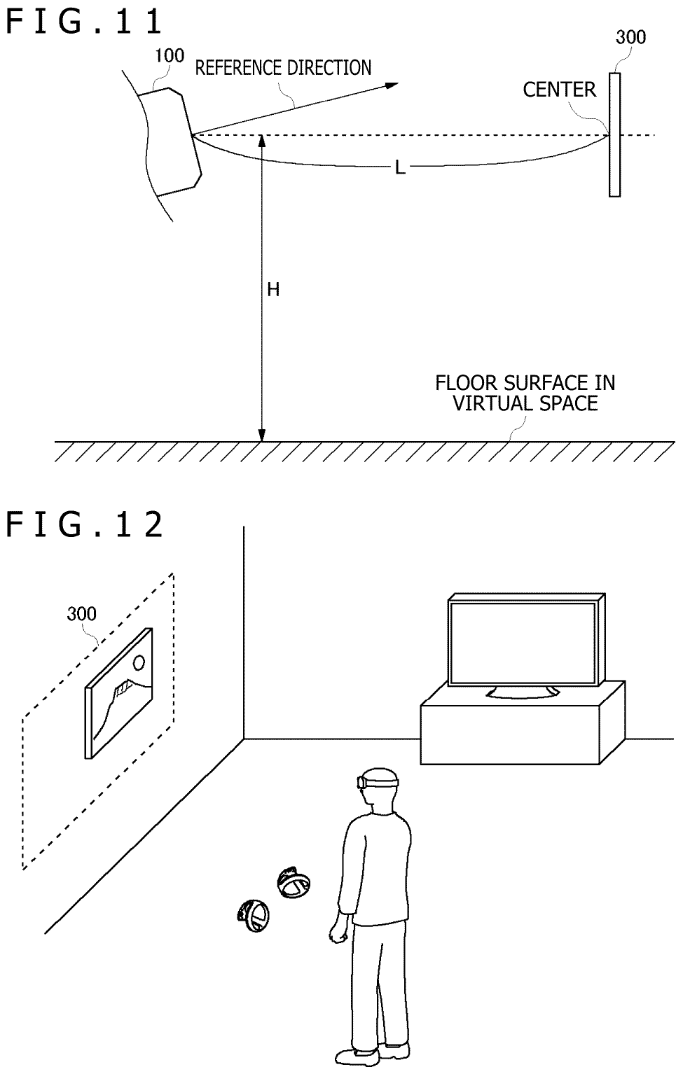

FIG. 11 is a diagram for explaining a method for deriving an arrangement position of the information element 300. The information element 300 is arranged in the virtual space in a manner standing along a vertical direction. The arrangement position determination section 232 adjusts the height of the center of the information element 300 to agree with the height H of the HMD 100 in the virtual space. It is to be noted that the height H of the HMD 100 may be a height estimated by the SLAM processing section 220.

The arrangement position determination section 232 also determines the position of the center of the information element 300 at a position separated by a predetermined distance L from the HMD 100 in a direction of a horizontal component of the reference direction (as indicated by a dashed line). The distance L is set to such a distance that the center of the information element 300 is not too close to or not too far from the HMD 100, and may be set to 1.2 meters, for example. The orientation (posture) of the two-dimensionally rectangular information element 300 is set such that the information element 300 lies perpendicularly to the direction of the horizontal component of the reference direction. The arrangement position determination section 232 provides the image generation section 240 with the determined arrangement position of the information element 300.

FIG. 12 illustrates an example of the arrangement position of the information element 300 in the virtual space.

The image generation section 240 arranges the information element 300 in the virtual space at the arrangement position determined by the arrangement position determination section 232. Specifically, the image generation section 240 sets the center of the information element 300 to the position that is separated by the predetermined distance L from the HMD 100 and is at the same height as the HMD 100, and arranges the information element 300 such that the two-dimensionally rectangular information element 300 crosses the direction of the horizontal component of the reference direction with the HMD 100 as a reference point. Since the information element 300 is arranged in the manner standing along the vertical direction in the embodiment, the horizontal component of the reference direction with the HMD 100 as the reference point perpendicularly penetrates the center of the information element 300.

As described above, the image generation section 240 arranges the information element 300 in the real space image at the position derived on the basis of the reference direction, and the image provision section 242 provides the HMD 100 with the image thus generated, through the communication section 202.

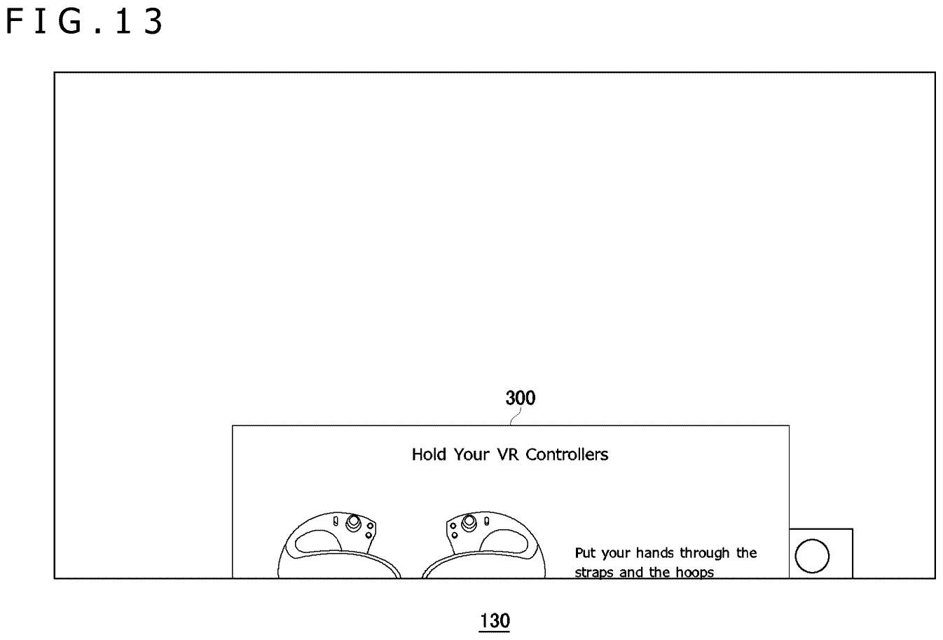

FIG. 13 illustrates an example of the information element 300 displayed on the display panel 130. Since the height of the center of the information element 300 is made to agree with the height of the HMD 100, when the user faces in a direction upper than the horizontal direction, the information element 300 is displayed on a lower side in the screen of the display panel 130. For the same reason, when the user faces in a direction lower than the horizontal direction, the information element 300 is displayed on an upper side in the screen of the display panel 130.

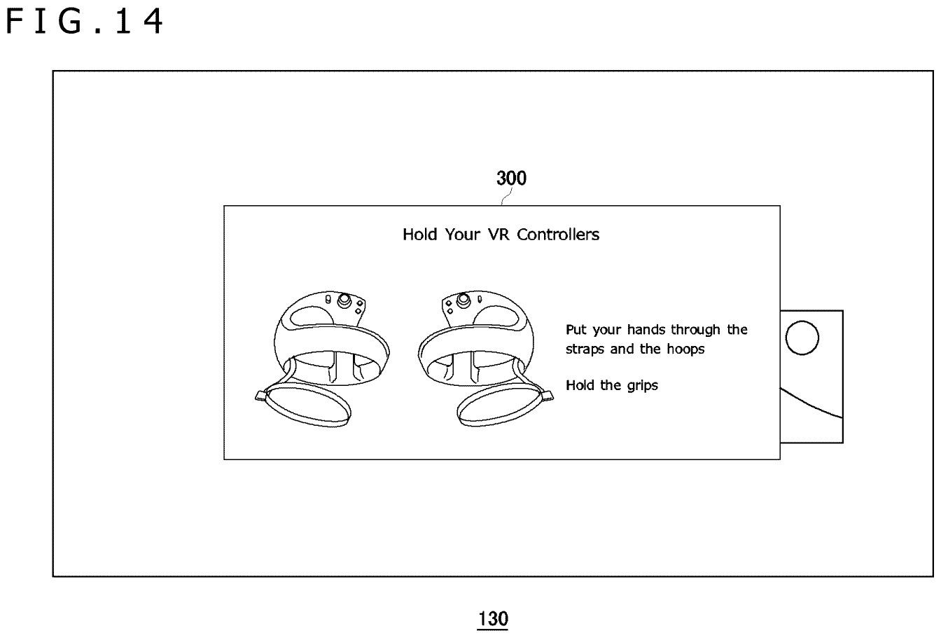

FIG. 14 illustrates an example of the information element 300 displayed on the display panel 130. Since the height of the center of the information element 300 is made to agree with the height of the HMD 100, when the user faces in the horizontal direction, the information element 300 is displayed at a heightwise central part of the display panel 130. By adjusting the height of the center of the information element 300 to the height of the HMD 100, it is possible for the user to look at the information element 300 with a natural posture facing the horizontal direction.

In the manner described above, the information element 300 is arranged at the initial position derived on the basis of the reference direction, and the display position of the information element 300 is fixed and the information element 300 does not move until a predetermined condition is satisfied. For convenience of explanation, the reference direction used in deriving the initial position of the information element 300 is called the “reference direction S” below. The reference direction acquisition section 230 acquires the reference direction that changes every moment, and the arrangement position determination section 232 monitors changes in the reference direction acquired by the reference direction acquisition section 230 and determines whether or not the changes in the reference direction satisfy a predetermined display position change condition.

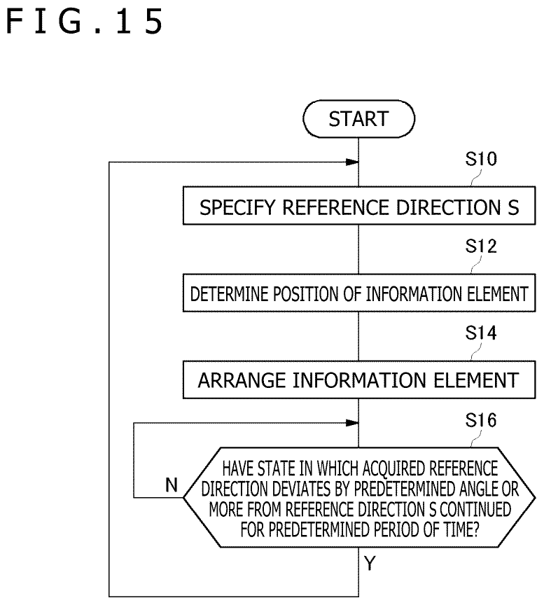

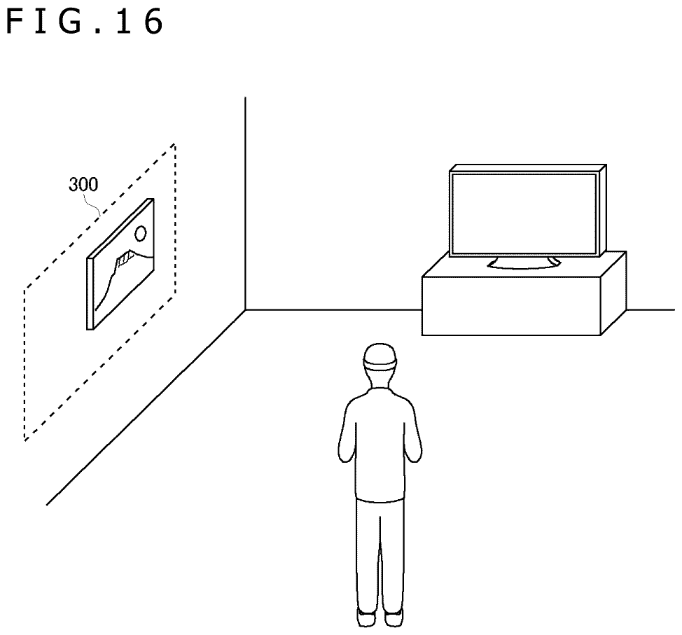

FIG. 15 illustrates a flowchart for determining the arrangement position of the information element 300. The reference direction acquisition section 230 acquires the reference direction in a predetermined cycle, and the arrangement position determination section 232 specifies the reference direction S at the time when the display of the information element 300 is started (S10). The arrangement position determination section 232 derives the arrangement position of the information element 300 on the basis of the reference direction S (S12), and the image generation section 240 arranges the information element 300 in the real space image at the position derived by the arrangement position determination section 232 (S14).

After the information element 300 is arranged, the arrangement position determination section 232 monitors changes in the reference direction derived by the reference direction acquisition section 230. The arrangement position determination section 232 determines whether or not a state in which the reference direction deviates by a predetermined angle or more from the reference direction S used at the time of arranging the information element 300 has continued for a predetermined period of time (S16). Here, the predetermined angle may be set to substantially a half of a screen viewing angle of the display panel 130. In a case in which the screen viewing angle is 110 degrees, for example, the predetermined angle may be set to 50 degrees. With the predetermined angle set in this manner, a state in which at least part of the information element 300 is not displayed is treated as a condition for changing the display position of the information element 300.

It is to be noted that the predetermined angle in the display position change condition may be set as an angle in the horizontal direction. Hence, the arrangement position determination section 232 may determine whether or not a state in which the reference direction horizontally deviates by the predetermined angle or more from the reference direction S after the information element 300 is arranged has continued for the predetermined period of time.

The predetermined period of time in the display position change condition is preferably set to a period of time shorter than one second, and may be 0.8 seconds, for example. Through testing of various periods of time, the present disclosers have figured out that, if a state in which the information element 300 is not visible at all continues for one second or more, the user has lost sight of the information element 300 too long, and this seems not appropriate for guidance. To avoid this situation, in the embodiment, when a state in which the reference direction horizontally deviates by 50 degrees or more from the reference direction S has continued for 0.8 seconds (Y in S16), the arrangement position determination section 232 specifies the reference direction acquired at that time by the reference direction acquisition section 230 as a new reference direction S (S10). The arrangement position determination section 232 derives a new position of the information element 300 on the basis of the new reference direction S (S12), and the image generation section 240 changes the position of the information element 300 in the real space image (S14). That is, the image generation section 240 rearranges the information element 300 to the position derived on the basis of the reference direction acquired at the time when the display position change condition is satisfied.

If the state in which the reference direction deviates by 50 degrees or more from the reference direction S has not continued for 0.8 seconds (N in S16), on the other hand, the arrangement position determination section 232 does not change the position of the information element 300 in the real space image and keeps monitoring changes in the reference direction.

In the see-through viewing mode, it is necessary that the user be able to check the surrounding situation. For example, in a case in which the user looks down to see where the input devices 16 are placed on the floor, if the information element 300 is always displayed on the display panel 130, it is difficult for the user to find the input devices 16. To avoid this, by fixing the position of the information element 300 unless the display position change condition indicated in S16 is satisfied, it is possible to make it easier for the user to check the surrounding situation. Moreover, since the user looks down for, for example, checking for obstacles on the floor in many cases after putting on the HMD 100, the height of the information element 300 is set to the height of the HMD 100, so that the information element 300 does not disturb the field of view of the user when the user looks down.

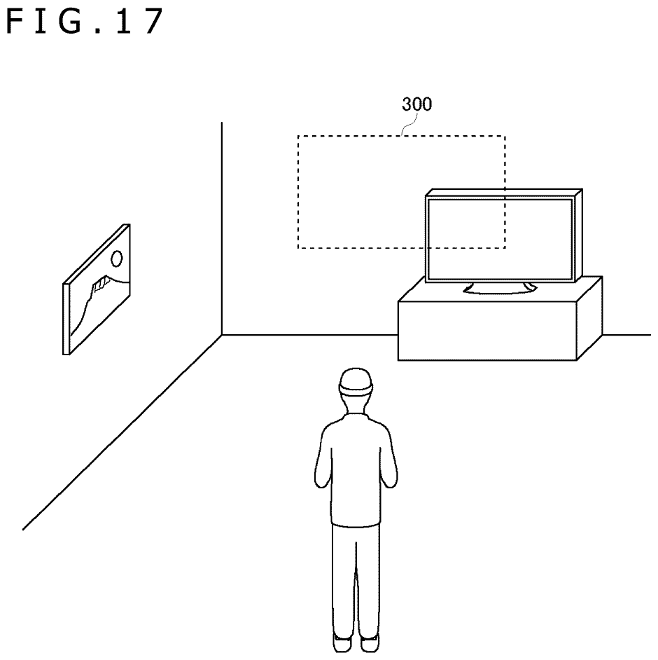

FIG. 16 illustrates an example of the arrangement position of the information element 300 in the virtual space.

In this example, the user's face has turned to the right (direction where the TV is disposed) from the state illustrated in FIG. 12. At this time, the arrangement position determination section 232 detects that the reference direction has horizontally deviated by the predetermined angle (50 degrees, for example) or more from the reference direction S used at the time of arranging the information element 300. Until this state continues for the predetermined period of time (0.8 seconds, for example), the arrangement position determination section 232 keeps the position of the information element 300 unchanged.

FIG. 17 illustrates an example of the arrangement position of the information element 300 in the virtual space.

If the state in which the reference direction horizontally deviates by the predetermined angle or more from the reference direction S used at the time of arranging the information element 300 has continued for the predetermined period of time, the arrangement position determination section 232 acquires the reference direction at the time when the predetermined period of time has elapsed, as a new reference direction S, and derives a new arrangement position of the information element 300 on the basis of the new reference direction S. The image generation section 240 arranges the information element 300 in the real space image at the position derived by the arrangement position determination section 232, and the image provision section 242 provides the HMD 100 with the image thus generated.

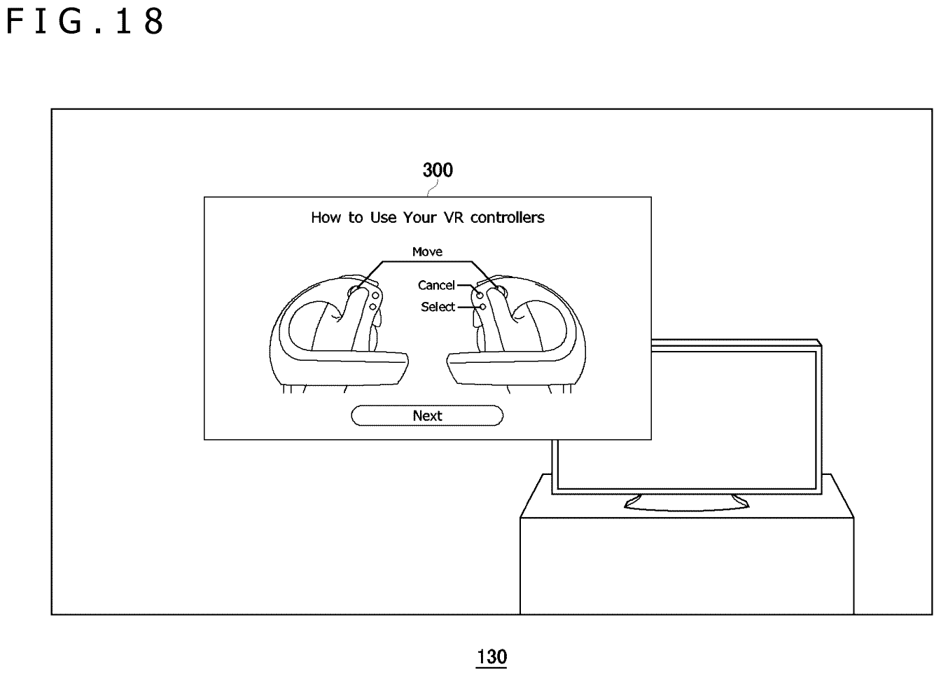

FIG. 18 illustrates an example of the information element 300 displayed on the display panel 130. Since the display position change condition has been satisfied, the information element 300 is now displayed at the new position in the real space image. The information element 300 follows the changes in the reference direction with slight delay, so that the user can check the information element 300 without large delay even when the user moves the head.

When changing the position of the information element 300, the image generation section 240 preferably moves the information element 300 from the original position (called a “position A”) to the new position (called a “position B”) while changing the moving speed. The length of time of movement is set to 0.5 to 0.6 seconds, for example. After the display position change condition is satisfied, the image generation section 240 moves the information element 300 in such a manner that the speed at the start of moving the information element 300 from the position A is relatively high and the speed at the time of stopping the movement of the information element 300 at the position B is relatively low. Through testing of various ways of moving, the present disclosers have figured out that moving the information element 300 from the position A to the position B at a constant speed can cause motion sickness. The present disclosers have thus solved this problem by changing the moving speed.

It is to be noted that, if the distance between the HMD 100 and the information element 300 becomes short, the information element 300 is displayed large on the display panel 130, and it becomes hard for the user to confirm the information presented by the information element 300. Hence, when the HMD 100 approaches the information element 300, the arrangement position determination section 232 changes the position of the information element 300 in the real space image such that the distance between the HMD 100 and the information element 300 does not fall below a predetermined threshold. Since the arrangement position determination section 232 determines the position of the information element 300 at the position separated by the predetermined distance L (1.2 meters, for example) from the HMD 100 as described above, the threshold may be set to a value smaller than the distance L, for example, 1.1 meters. With such a limitation set on the approach distance, the information element 300 displayed on the display panel 130 can always be maintained in an easy-to-see state.

If the distance between the HMD 100 and the information element 300 becomes large, on the other hand, the information element 300 is displayed small on the display panel 130, and it becomes possible for the user to see a wider range of the real space. Hence, even when the HMD 100 moves away from the information element 300, the arrangement position determination section 232 does not change the position of the information element 300 in the real space image.

The user is allowed to operate the operation members 82 of the input devices 16 during the see-through viewing mode. For example, when the user operates a predetermined operation member 82 in a state in which the information element 300 illustrated in FIG. 18 is displayed, the operation acceptance section 234 accepts the operation as selection of “Next” button, and the information element generation section 236 generates another information element 300 for presenting next guidance. Meanwhile, sometimes the user can make erroneous operation on an operation member 82, for example, the user can make an erroneous operation on an operation member 82 in a situation in which the user is not looking at the information element 300. In this case, it is not favorable that the next guidance screen is displayed.

To avoid this, after the information element 300 is arranged, when the reference direction deviates by a predetermined second angle or more from the reference direction S used at the time of arranging the information element 300, the operation acceptance section 234 invalidates the operation on the operation member 82. In other words, the operation acceptance section 234 ignores the operation on the operation member 82 and does not accept the operation of selecting the “Next” button. The predetermined second angle may be, for example, smaller than the angle used in the display position change condition. The predetermined second angle may be set in each of the horizontal direction and the vertical direction, for example, the angle in the horizontal direction may be set to 38 degrees while the angle in the vertical direction may be set to 32 degrees.

The present disclosure has been described above on the basis of the embodiment. The embodiment described above is illustrative only, and it is understood by those skilled in the art that various modifications can be made to the combinations of the respective components and processing processes and that such modifications also fall within the scope of the present disclosure. While the information processing device 10 performs the image generation processing in the embodiment, the functions of the information processing device 10 may be provided in the HMD 100 such that the HMD 100 performs the image generation processing. That is, the HMD 100 may act as the information processing device 10.

### INDUSTRIAL APPLICABILITY

The present disclosure is applicable to a technology for generating an image to be displayed on an HMD.

### REFERENCE SIGNS LIST

1: Information processing system
10: Information processing device
14: Imaging device
16: Input device
82: Operation member
100: HMD
112: Infrared camera
120: Control section
122: Storage section
124: IMU
126: Microphone
128: Communication control section
130: Display panel
132: Audio output section
200: Processing section
202: Communication section
210: Acquisition section
212: Captured image acquisition section
214: Sensor data acquisition section
216: Operational information acquisition section
220: SLAM processing section
222: Posture acquisition section
230: Reference direction acquisition section
232: Arrangement position determination section
234: Operation acceptance section
236: Information element generation section
240: Image generation section
242: Image provision section
300: Information element

1. An information processing device comprising:
one or more processors having hardware, wherein
the one or more processors
generate a real space image to be displayed on a head-mounted display worn on a head of a user,
acquire a reference direction associated with a line of sight of the user,
arrange an information element in the real space image at a position derived on a basis of the reference direction, and
change the position of the information element in the real space image when, after the information element is arranged, a state in which the reference direction deviates by a predetermined angle or more from the reference direction used at a time of arranging the information element has continued for a predetermined period of time.

2. The information processing device according to claim 1, wherein the one or more processors
acquire an image captured by an imaging device provided on the head-mounted display, and
generate, as the real space image, a surrounding image with the head-mounted display as a reference point by use of the captured image thus acquired.

3. The information processing device according to claim 1, wherein the one or more processors acquire a direction in which the head-mounted display faces as the reference direction.

4. The information processing device according to claim 1, wherein the one or more processors acquire a sight direction of the user as the reference direction.

5. The information processing device according to claim 1, wherein the one or more processors arrange the information element such that the information element crosses a direction of a horizontal component of the reference direction.

6. The information processing device according to claim 5, wherein the one or more processors arrange the information element at a position separated by a predetermined distance from the head-mounted display.

7. The information processing device according to claim 5, wherein the one or more processors arrange the information element at a position corresponding in height to a position of the head-mounted display.

8. The information processing device according to claim 1, wherein the one or more processors change the position of the information element in the real space image when, after the information element is arranged, a state in which the reference direction horizontally deviates by the predetermined angle or more from the reference direction used at the time of arranging the information element has continued for the predetermined period of time.

9. The information processing device according to claim 1, wherein, when, after the information element is arranged, the state in which the reference direction deviates by the predetermined angle or more from the reference direction used at the time of arranging the information element has continued for the predetermined period of time, the one or more processors arrange the information element at a position derived on a basis of the reference direction acquired at the time when the predetermined period of time has elapsed.

10. The information processing device according to claim 1, wherein, when the head-mounted display approaches the information element, the one or more processors change the position of the information element in the real space image such that a distance between the head-mounted display and the information element does not fall below a predetermined threshold.

11. The information processing device according to claim 10, wherein the one or more processors do not change the position of the information element in the real space image even when the head-mounted display moves away from the information element.

12. The information processing device according to claim 1, wherein the one or more processors invalidate operation on an operation member when, after the information element is arranged, the reference direction deviates by a predetermined second angle or more from the reference direction used at the time of arranging the information element.

13. An image generation method comprising:
a step of generating a real space image to be displayed on a head-mounted display worn on a head of a user;
a step of acquiring a reference direction associated with a line of sight of the user;
a step of arranging an information element in the real space image at a position derived on a basis of the reference direction; and
a step of changing the position of the information element in the real space image when, after the information element is arranged, a state in which the reference direction deviates by a predetermined angle or more from the reference direction used at a time of arranging the information element has continued for a predetermined period of time.

14. A program for causing a computer to realize:
a function of generating a real space image to be displayed on a head-mounted display worn on a head of a user;
a function of acquiring a reference direction associated with a line of sight of the user;
a function of arranging an information element in the real space image at a position derived on a basis of the reference direction; and
a function of changing the position of the information element in the real space image when, after the information element is arranged, a state in which the reference direction deviates by a predetermined angle or more from the reference direction used at a time of arranging the information element has continued for a predetermined period of time.
